(19) United States
(12) Patent Application Publication
(10) Pub. No.: US 2007/0273974 A1
(43) Pub. Date: Nov. 29, 2007

(54) Light Diffusing Member For Transmission Screen

(75) Inventors: Shigeki Baba, Tokyo-To (JP); Norihiko Otaka, Tokyo-To (JP); Yukifumi Uotani, Tokyo-To (JP); Koichi Nakano, Tokyo-To (JP); Koji Hashimoto, Tokyo-To (JP)

Correspondence Address: BURR & BROWN, PO BOX 7068, SYRACUSE, NY, 13261-7068, US

(73) Assignee: Dai Nippon Printing Co., Ltd, Shinjuku-Ku (JP)

(21) Appl. No.: 10/591,721

(22) PCT Filed: Mar. 11, 2005
(86) PCT No.: PCT/JP05/04287

§ 371 Date: Jan. 30, 2007

(30) Foreign Application Priority Data
Mar. 12, 2004 (JP) 2004-070696

(51) Int. Cl. G02B 5/02

(52) U.S. Cl. 359/599

(57) ABSTRACT

There is provided a light diffusing member for use in a transmission screen, which has an excellent surface protective effect while maintaining an antireflection effect. The light diffusing member for use in a transmission screen comprises a hard coat layer provided on a surface of a substrate having a single or multilayer structure. The substrate contains fine particles, and the surface gloss of the hard coat layer as measured under conditions of incident angle 60°/reflection angle 60° is 60 to 80 by supposing the surface gloss of a gloss standard plate to be 100.

### TECHNICAL FIELD

This invention relates to a light diffusing member for use in transmission screens used, for example, in transmission projection televisions, and an optical member and a transmission screen using the light diffusing member.

### BACKGROUND ART

Transmission projection televisions are display devices for enlarging and projecting images from light sources such as CRTs, liquid crystal projectors, and DLPs onto transmission screens. In such display devices, in order to reduce dazzling when a screen is viewed, for example, light diffusing plates and the like for diffusing outgoing light are provided on a screen surface. Further, in order to reduce a deterioration in visibility of projected images caused by reflection of external light from the screen surface, an antireflection film is sometimes provided on the screen surface. For example, as disclosed in Japanese Patent Laid-Open No. 295818/1999 and Japanese Patent Laid-Open No. 28169/1995, the light diffusing plate and antireflection film are prepared by incorporating transparent fine particles such as organic fillers in resins constituting these light diffusing plates and the like. Further, the light diffusing plate and antireflection film, which simultaneously has an antireflection effect attained by protruding transparent fine particles on the surface of the resin to form concaves and convexes on the surface of a light diffusing plate, has been developed.

The provision of a protective layer (also referred to as “hard coat layer”) on the surface of the light diffusing plate for screen surface protection purposes, however, poses a problem that the concaves and convexes on the light diffusing plate surface disappear and, consequently, the antireflection effect cannot be attained.

On the other hand, when the provision of the protective layer satisfactory for attaining the antireflection effect is contemplated, however, the thickness of the protective layer should be smaller than the level of the concaves and convexes on the surface of a light diffusing plate, that is, the particle diameter of the transparent fine particles, and, consequently, disadvantageously, a satisfactory surface protective effect cannot be attained.

### DISCLOSURE OF THE INVENTION

The present inventors have now found that, in the provision of a hard coat layer on a light diffusing plate, the surface hardness and surface gloss of the hard coat layer can be regulated bhoy regulating the particle diameter and content of the fine particles contained in the substrate and the thickness of the resin constituting the hard coat layer, and, consequently, a light diffusing member having a satisfactory surface protective effect can be realized while maintaining the antireflection effect. The present invention has been made based on such finding.

Accordingly, an object of the present invention is to provide a light diffusing member for use in transmission screens, which simultaneously has antireflection effect and excellent surface protective effect.

The above object of the present invention can be attained by a light diffusing member for a transmission screen, comprising: a substrate having a single or multilayer structure; and a hard coat layer provided on a surface of the substrate, wherein the substrate contains fine particles, and the surface gloss of the hard coat layer as measured under conditions of incident angle 60°/reflection angle 60° is 60 to 80 by supposing the surface gloss of a gloss standard plate to be 100. In a preferred embodiment, the hard coat layer has a surface hardness of 3 H or more as measured by a pencil hardness test according to JIS K 5600-5-4. The provision of a hard coat layer having the above surface hardness on a viewer side (outermost surface) can realize satisfactory surface protective effect while maintaining antireflection effect.

### BRIEF DESCRIPTION OF THE DRAWINGS

FIG. 1 is a cross-sectional typical view of a light diffusing member according to the present invention.

FIG. 2 is a cross-sectional typical view of a light diffusing member in another aspect of the present invention.

FIG. 3 is a typical cross-sectional view of an embodiment of an optical member using a light diffusing member according to the present invention.

FIG. 4 is a typical cross-sectional view of an embodiment of an optical member using a light diffusing member according to the present invention.

FIG. 5 is a typical cross-sectional view of an embodiment of an optical member using a light diffusing member according to the present invention.

FIG. 6 is a typical cross-sectional view of an embodiment of an optical member using a light diffusing member according to the present invention.

FIG. 7 is a typical cross-sectional view of an embodiment of an optical member using a light diffusing member according to the present invention.

FIG. 8 is a typical cross-sectional view of an embodiment of an optical member using a light diffusing member according to the present invention.

FIG. 9 is a typical cross-sectional view of an embodiment of a transmission screen according to the present invention.

FIG. 10 is a typical cross-sectional view of an embodiment of a transmission screen according to the present invention.

FIG. 11 is a typical cross-sectional view of an embodiment of a transmission screen according to the present invention.

### DETAILED DESCRIPTION OF THE INVENTION

The light diffusing member according to the present invention will be described.

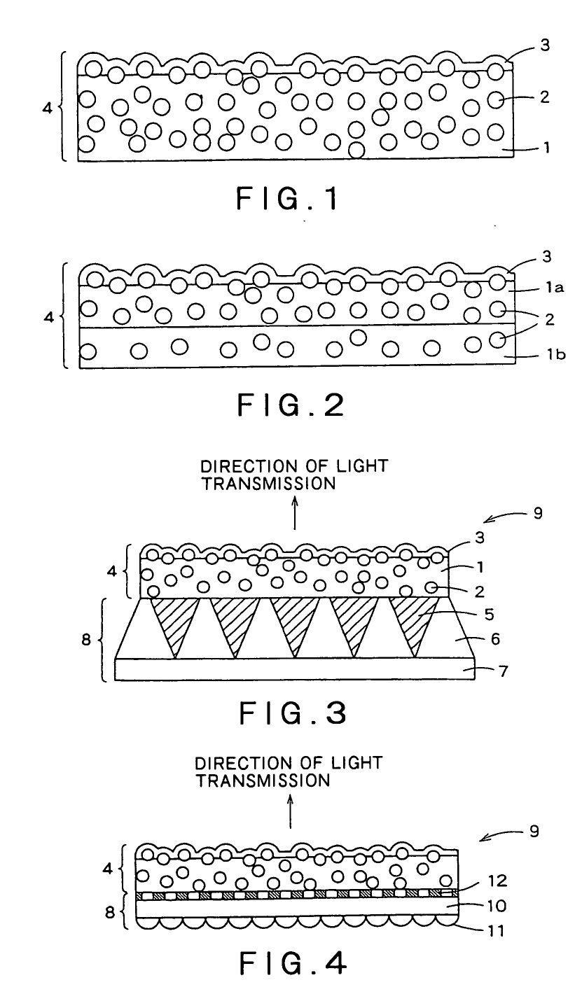

As shown in FIG. 1, the light diffusing member according to the present invention has a structure comprising a hard coat layer 3 provided on a surface of a substrate 1 containing fine particles 2. The hard coat layer is provided on the foreground on a viewer side. The foreground on a viewer side means that the light diffusing member, when incorporated in a transmission screen, is located on the outermost surface on a transmitted light viewing side.

In the light diffusing member according to the present invention, the surface gloss of the hard coat layer provided on the substrate is 60 to 80 as measured under conditions of angle of incidence 60°/angle of reflection 60°. The term “surface gloss” as used herein refers to a relative value determined using a glass plate having a refractive index of 1.567 according to JIS K 5600-4-7 as a standard gloss plate by supposing the surface gloss of the standard gloss plate to be 100. When the surface gloss of the hard coat layer constituting the light diffusing member according to the present invention is 60 to 80, an antireflection effect which is excellent for transmission screen applications can be provided. When the surface gloss is less than 60, the light diffusion on the surface of the hard coat layer is significant. As a result, the haze value is increased, and light transmittance as a screen is lowered. When the surface gloss exceeds 80, regular reflection of light on the surface of the hard coat layer is dominant and, consequently, reflection of external light from the screen disadvantageously occurs. The surface gloss can be measured with a conventional gloss meter (for example, a handy gloss meter: GLOSS CHECKER IG-330; manufactured by Sanwa Kenma Ltd.). In order that the hard coat layer has the above surface hardness and surface gloss, the particle diameter and content of the fine particles contained in the substrate and the thickness of the resin constituting the hard coat layer should be in the following respective ranges.

A hard coat layer 3 preferably has a thickness of 3 to 15 μm. When the thickness of the hard coat layer is in the above-defined range, regardless of the material for the substrate, the surface hardness of the hard coat layer can be brought to 3 H or more as measured by a pencil hardness test specified in JIS K 5600-5-4. When the thickness of the hard coat layer is less than 3 μm, satisfactory surface hardness cannot be realized due to the influence of the hardness of the material constituting the underlying substrate and, consequently, the effect of preventing damage to the screen cannot be attained. On the other hand, when the thickness of the hard coat layer exceeds 15 μm, the thickness of the hard coat layer is so large that the shape of concaves and convexes formed by fine particles of the surface of the substrate cannot be traced on the surface of the hard coat layer and, consequently, the antireflection effect cannot be expected. The thickness of the hard coat layer is more preferably 5 to 10 μm.

The fine particles 2 contained in the substrate 1 preferably has an average particle diameter of 5 to 15 μm. When the average particle diameter is less than 5 μm, the surface of the formed hard coat layer is so smooth that the antireflection effect cannot be attained. On the other hand, when the average particle diameter of the fine particles exceeds 15 μm, the surface of the hard coat layer is rough, and, consequently, the antireflection effect is reduced.

The fine particles are preferably contained in an amount of 10 to 20% by weight based on the substrate. When the amount of the fine particles exceeds 20% by weight, the effect of diffusing light by the fine particles is so large that the haze value as the transmission screen is increased. As a result, no satisfactory transmittance can be provided. On the other hand, when the content of the fine particles is less than 10% by weight, the effect of diffusing light is unsatisfactory, and the surface gloss of the hard coat layer disadvantageously exceeds 80.

Transparent resin films, transparent resin plates, transparent resin sheets, and transparent glasses are usable as the substrate in the present invention. Suitable transparent resin films include triacetate cellulose (TAC) films, polyethylene terephthalate (PET) films, diacetylcellulose films, cellulose acetate butyrate films, polyethersulfone films, polyacrylic resin films, polyurethane resin films, polyester films, polycarbonate films, polysulfone films, polyether films, polymethylpentene films, polyetherketone films, and (meth)acrylonitrile films. The thickness of the substrate is generally about 0.025 mm to 2 mm.

Organic fillers such as plastic beads are suitable as fine particles 2 contained in the substrate 1 used in the present invention. Particularly preferred are fine particles that have high transparency and have a difference in refractive index from the hard coat layer which will be described later of about 0.05.

Suitable plastic beads include melamine beads (refractive index 1.57), polyacrylic beads (refractive index 1.49), polycarbonate beads, polyethylene beads, polystyrene beads (1.60), polyvinyl chloride beads, and beads of copolymer resins such as acryl-styrene copolymer resin beads. In the beads of the copolymer resins, the refractive index can be varied by varying the content of the monomers. Among them, polyacrylic beads or methacryl-styrene copolymer (MS) beads are preferred. The particle diameter of the plastic beads is 5 to 15 μm as described above.

In the present invention, as shown in FIG. 1, a hard coat layer 3 may be provided on a substrate 1 having a single layer structure. As shown in FIG. 2, the substrate 1 may have a two-layer structure of a substrate 1a and a substrate 1b. The content of the fine particles contained in the substrate 1a should be in the above-defined range. The content of the fine particles contained in the substrate 1b is preferably lower than the content of the fine particles contained in the substrate 1a. When the content of the fine particles in the substrate 1b is reduced, in a combination with an optical member such as a horizontal viewing angle enlarging member which will be described later, the bonded surface is so smooth that the adhesion between the light diffusing member 4 and the optical member is enhanced.

The hard coat layer constituting the light diffusing member according to the present invention may be formed from a resin curable upon exposure to ultraviolet light or electron beams, that is, an ionizing radiation curing resin, or a mixture of the ionizing radiation curing resin with a thermoplastic resin and a solvent, or a heat curing resin. Among them, ionizing radiation curing resins are particularly preferred.

In the ionizing radiation curing resin composition, preferred film forming components include those containing an acrylate-type functional group, and examples thereof include a polyester resin, a polyether resin, an acrylic resin, an epoxy resin, a urethane resin, an alkyd resin, a spiroacetal resin, a polybutadiene resin, and a polythiol-polyene resin having a relatively low molecular weight, an oligomer or a prepolymer of a (meth)acrylate or the like of a polyfunctional compound, such as a polyhydric alcohol, and those containing a relatively large amount of a reactive diluent, such as a monofunctional monomer, such as ethyl(meth)acrylate, ethylhexyl(meth)acrylate, styrene, methylstyrene, or N-vinylpyrrolidone, and a polyfunctional monomer, for example, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

In order to bring the above ionizing radiation curing resin composition to ultraviolet light curing type, it is preferred to incorporate, into the ionizing radiation curing resin composition, a photopolymerization initiator, such as an acetophenone compound, a benzophenone compound, Michler's benzoylbenzoate, an α-amyloxime ester, tetramethyl thiuram monosulfide, or a thioxanthone compound, and a photosensitizer, such as n-butylamine, triethylamine, or poly-n-butylphosphine. In the present invention, it is particularly preferred to incorporate urethane acrylate or the like as an oligomer and dipentaerythritol hexa(meth)acrylate or the like as a monomer.

The ionizing radiation curing resin composition can be cured by any conventional curing method used for curing the conventional ionizing radiation curing resin composition, that is, by irradiation with an electron beam or ultraviolet light.

For example, in the case of curing by irradiation with an electron beam, an electron beam having an energy of 50 to 1000 KeV, preferably 100 to 300 KeV, may be used which is emitted from various electron beam accelerators, such as a Cockcroft-Walton (type) accelerator, a van de Graaff accelerator, a resonance transformer accelerator, an insulated core transformer accelerator, a linear accelerator, a Dynamitron accelerator, and a high-frequency accelerator. On the other hand, in the case of curing by irradiation with ultraviolet light, ultraviolet light may be used which is emitted from light sources, such as an extra-high pressure mercury lamp, a high-pressure mercury lamp, a low-pressure mercury lamp, a carbon arc, a xenon arc, and a metal halide lamp.

The hard coat layer constituting the light diffusing member according to the present invention may be formed by coating a coating liquid of the above ionizing radiation (ultraviolet light) curing resin composition onto a surface of a substrate by spin coating, die coating, dip coating, bar coating, flow coating, roll coating, or gravure coating, and curing the coating liquid by the above means.

Next, a transmission screen using the light diffusing member according to the present invention will be described.

The light diffusing member 4 according to the present invention may be used in combination with a horizontal viewing angle enlarging member 8 as shown in FIG. 3. In the present invention, the light diffusing member is disposed on the foreground in the direction of light transmission. In the optical member 9 shown in FIG. 3, a light diffusing member 4 is provided on the foreground in the direction of light transmission. The horizontal viewing angle enlarging member 8 generally has a structure comprising a lens 6 provided on a lens substrate 7. In the present invention, the horizontal viewing angle enlarging member 8 may be as shown in FIG. 3. Specifically, as shown in FIG. 3, a transparent resin part 6 and a light absorbing part (a light shielding part) 5 are used in combination so that the boundary surface between the transparent resin part 6 and the light absorbing part 5 constitutes a reflecting surface, whereby this combination develops a lens function. The assembly of the transparent resin part and the light absorbing part is provided on the lens substrate 7 to constitute the horizontal viewing angle enlarging member 8. In the present invention, the combination of the horizontal viewing angle enlarging member 8 with the light diffusing member 4 can realize images which are free from reflection of external light on the screen, are excellent in visibility, and have good contrast and sharpness.

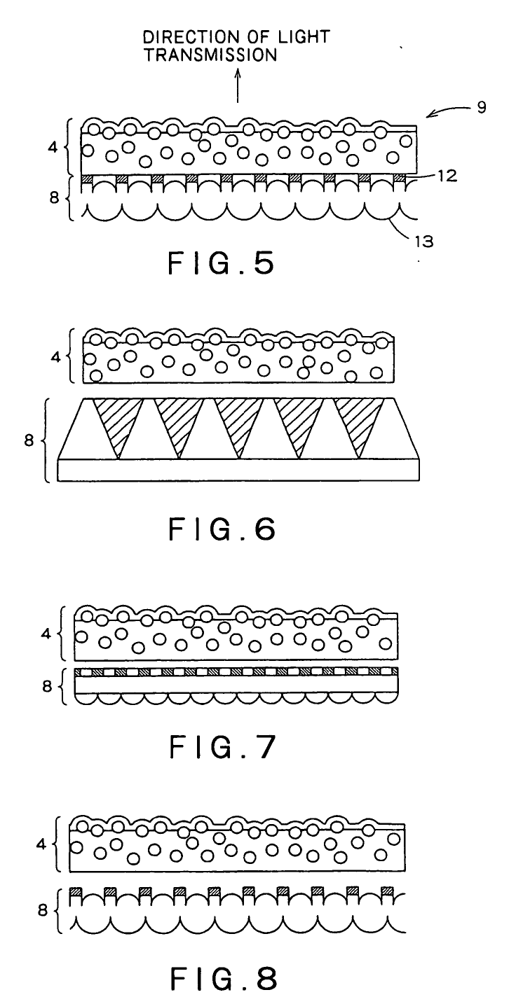

Further, in the present invention, as shown in FIG. 4, the light diffusing member may be used in combination with a cylindrical lens member 11 to constitute an optical member. The cylindrical lens member 11 is provided on one side of the lens substrate 10, and a light absorbing part (a light shielding part) 12 is provided on the other side of the lens substrate 10. As shown in FIG. 5, a lenticular lens member 13 may be used as the horizontal viewing angle enlarging member comprising a combination of a cylindrical lens member with a light absorbing part.

Further, in the optical member using the light diffusing member, the light diffusing member may be bonded to the lens member through a pressure-sensitive adhesive layer (not shown). Further, as shown in FIGS. 6 to 8, the light diffusing member and the horizontal viewing angle enlarging member or the lens member may be combined in such a state that they are not bonded to each other.

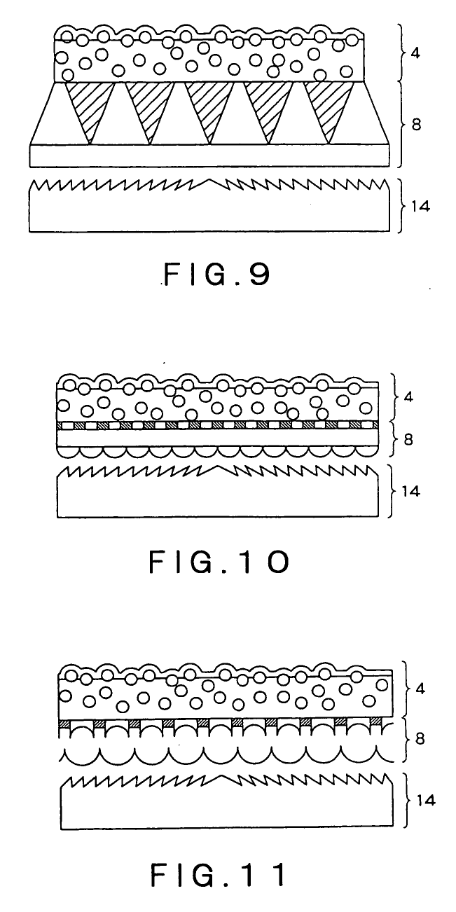

As shown in FIGS. 9 to 11, the transmission screen according to the present invention has a structure comprising a combination of the optical member with a Fresnel lens member 14. In the present invention, when the light diffusing member 4 comprising a hard coat layer having a surface hardness of 3 H or more is disposed on the outermost surface (viewer side) of a transmission screen, a transmission screen can be realized which is free from reflection of external light or the like on the screen and is less likely to scratch the screen surface.

### EXAMPLES

The following Examples further illustrate the present invention. However, it should be noted that the present invention is not limited to these Examples.

MS (methacryl-styrene copolymer) resin (refractive index 1.53) was provided as a resin used in a substrate of a light diffusing member. MS beads (refractive index 1.49, average particle diameter 10 μm) were provided as fine particles to be added to the substrate. The fine particles were added in an amount of 15% by weight to the substrate. The mixture was extruded with a melt extruder to prepare a substrate for a light diffusing member.

Next, an ultraviolet curing resin composition composed mainly of urethane acrylate was dip coated onto a surface of the substrate. The coating was exposed to ultraviolet light to cure the resin composition and thus to form a hard coat layer on the substrate, whereby a light diffusing member was prepared. The thickness of the hard coat layer was regulated by regulating the speed of pulling up the substrate from the coating liquid in the formation of the hard coat layer by dip coating. In the same manner as described above, light diffusing members with varied hard coat layer thickness were prepared. The thickness of each hard coat layer was as shown in Table 1.

For the light diffusing members thus obtained, the surface gloss of the light diffusion member on its hard coat layer side was measured with a surface gloss meter (a handy gloss meter GLOSS CHECKER IG-330; manufactured by Sanwa Kenma Ltd.) under measuring conditions of angle of incidence 60°/angle of reflection 60°.

Further, for the light diffusing member on its hard coat layer side, a pencil scratch test was carried out according to JIS K 5600-5-4.

Further, a lenticular lens sheet was provided in combination with a Fresnel lens sheet, and the light diffusing member prepared above was incorporated on the lenticular lens side to prepare a transmission screen. The sensory evaluation was also carried out for image quality of the screen thus prepared. Further, external light was applied to the screen surface (light diffusing member side) in such a state that an image was projected to the transmission screen, for evaluating the reflection of external light from the screen surface.

The evaluation was carried out according to the following criteria.

1. Evaluation of Image Quality

◯: Screen is bright, and the outline of the image is clear.
Δ: Screen is somewhat white, and the outline of the image is somewhat blurry.
X: Screen is whitish, and the outline of the image is blurry.
   2. Evaluation of Reflection of External Light on Screen Surface
◯: The level of reflection on screen surface is weak, and the visibility of the image is good.
Δ: Image visibility is ordinary although reflection is observed.
X: The reflection level is very high, and the visibility of the image is poor.

The results of measurement and evaluation are as shown in Table 1.

TABLE 1

| | Hard coat | | | | |
|---|---|---|---|---|---|
| | layer film | | | | |
| | thickness | Surface | Surface | Image | |
| | (μm) | gloss | hardness | quality | Reflection |
| Example 1 | 3 | 62 | 3H | Δ | ∘ |
| Example 2 | 5 | 66 | 3H | ∘ | ∘ |
| Example 3 | 10 | 71 | 3H | ∘ | ∘ |
| Example 4 | 15 | 79 | 4H | ∘ | Δ |
| Comparative | 0 | 26 | H | x | ∘ |
| Example 1 | | | | | |
| Comparative | 1.5 | 47 | 2H | x | ∘ |
| Example 2 | | | | | |
| Comparative | 20 | 89 | 4H | ∘ | x |
| Example 3 | | | | | |
| Comparative | 30 | 110 | 4H | ∘ | x |
| Example 4 | | | | | |

1. A light diffusing member for a transmission screen, comprising: a substrate having a single or multilayer structure; and a hard coat layer provided on a surface of the substrate, wherein the substrate contains fine particles, and the surface gloss of the hard coat layer as measured under conditions of incident angle 60°/reflection angle 60° is 60 to 80 by supposing the surface gloss of a gloss standard plate to be 100.

2. The light diffusing member according to claim 1, wherein the hard coat layer has a surface hardness of 3 H or more as measured by a pencil hardness test according to JIS K 5600-5-4.

3. The light diffusing member according to claim 1, wherein the hard coat layer is provided on the foreground on a viewer side.

4. The light diffusing member according to claim 1, wherein the hard coat layer has a thickness of 3 to 15 μm.

5. The light diffusing member according to claim 1, wherein the fine particles have an average particle diameter of 5 to 15 μm.

6. The light diffusing member according to claim 1, wherein the fine particles are contained in an amount of 10 to 20% by weight in the substrate.

7. The light diffusing member according to claim 1, wherein the hard coat layer is formed of an ionizing radiation curing resin.

8. The light diffusing member according to claim 1, wherein the fine particles are formed of an acryl-styrene copolymer resin.

9. An optical member for a transmission screen, comprising a combination of a light diffusing member according to claim 1 with a horizontal viewing angle enlarging member, wherein the light diffusing member is disposed on the foreground in the direction of light transmission.

10. An optical member for a transmission screen, comprising a combination of a light diffusing member according to claim 1 with a lens member, wherein the light diffusing member is disposed on the foreground in the direction of light transmission.

11. The optical member for a transmission screen according to claim 10, wherein the lens member comprises a lenticular lens member.

12. A transmission screen comprising a combination of an optical member according to claim 9 with a Fresnel lens member.
